(19) United States
(12) Patent Application Publication
(10) Pub. No.: US 2016/0150772 A1
(43) Pub. Date: Jun. 2, 2016

(54) Wildlife deterrent and alerter

(71) Applicant: Lawrence Ahlfert Pearlman, South Boston, VA (US)

(72) Inventor: Lawrence Ahlfert Pearlman, South Boston, VA (US)

(21) Appl. No.: 14/757,142

(22) Filed: Nov. 24, 2015

(51) Int. Cl. A01M 29/10

(52) U.S. Cl. CPC A01M 29/10

(57) ABSTRACT

The invention is a self-contained apparatus which uses a sensor to detect, and negative sensory stimulus to deter, undesired wildlife, or human, encroachment, and alert users of the device of said encroachment. It does so by using a bright flashing strobe to destroy the animal's or human intruder's night vision and visually alert users of the device to the presence of animals or other intruders. The device described in this patent application uses light stimulus, but other sensory stimulus, including but not limited to smell or hearing, may be used.

### FIELD OF THE INVENTION

The invention falls into the fields of development, wildlife management and conservation, and security.

### BACKGROUND

Wildlife management is an important part of development in many non-industrialized countries. For farmers in areas with megafauna (Elephants, rhinos, etc), these animals may constitute a very real threat to their families and livelihood. Due to this threat, efforts at reductions in poaching are not always as successful as they might be: local farmers might actively welcome poaching, or even participate in it themselves, if it prevents encroachment by large animals. It is to the benefit of both the animal and human populations in such areas if a method is found which deters large, dangerous wild animals from wandering into, or claiming, areas in which human are active.

### SUMMARY OF THE INVENTION

The invention is a self-contained device which uses a proximity sensor to detect the presence of nearby wildlife, or unwanted human, movement. It has a power source, such as a battery or capacitator, powered by a source such as a solar panel, which it uses to emit a non-harmful sensory impulse. As described in this application, the device uses as a deterring impulse a strobe or flash similar to that of a typical camera. While other impulses such as auditory or even olfactoral or other sensory responses might be useful in certain circumstances, the description of the device will herein concentrate on visual light impulses (“Strobes” or “flashes”) for the sake of clarity.

The device is designed so as to be placed easily in any position in which it might perform its function, from mounting on a pole to being placed in shrubbery or a tree limb.

The device collects its energy from a self-contained source such as a solar panel. When movement of a sufficiently large animal, whether herbivore, predator, megafauna or, indeed, human, is detected within the range of motion detection, the unit will fire a deterring sensory stimulus such as a single, or series of, flashes. The device described in this application using light specifically is designed primarily for nocturnal use for two reasons: first, most wildlife encroachment occurs when humans are not present and active, i.e. at night. Second, wildlife in general do not react well to strobes or flashes in close proximity since they destroy the animals' night vision. Wild animals in particular show a marked reluctance to place themselves in situations where one of their important senses may be seriously compromised.

For these reasons, the device will provide a simple and relatively inexpensive method of deterring wildlife from specific areas.

### BRIEF DESCRIPTION OF DRAWINGS

The accompanying drawings further describe the invention.

FIG. 1 is a front view of a wildlife deterrent;

FIG. 2 is a side view of a wildlife deterrent in FIG. 1;

FIG. 3 is a top view of a wildlife deterrent in FIG. 1;

FIG. 4 illustrates components of an embodiment of a wildlife deterrent;

FIG. 5 is an alternative embodiment of a strobe light of a wildlife deterrent; and

FIG. 6 is a perspective view of components of an embodiment of the wildlife deterrent.

### DETAILED DESCRIPTION OF THE INVENTION

The three images are of the device from the front (Lower-right depiction with items 3 and 4 illustrated), side (lower left depiction, illustrating item 2) and top (Top depiction, illustrating item 1). These three depictions of the device are for illustrative purposes, so as to show the various components of the device, and should not be taken as a definitive version of the device with regards to the outer form and appearance of the case, or placement and composition of components within the device.

That said, the top illustration shows a solar panel 1 which provides electricity to the device. The electricity is stored in some form (In this example a battery, not seen here, is used) which powers, a motion sensor 3 which detects the movement of wildlife or intruders of any sort within range and, controlled by a microprocessor or circuit board, fires, a strobe or flash unit 4, which both destroys the night vision of the wildlife, and alerts users of the device to the presence of wildlife or intruders in the area.

Note that a photovoltaic sensor 2 which detects the level of ambient light and provides an input to the internal microprocessor or circuit board of when conditions are correct for the firing of the strobe (i.e. when it's dark). This is for illustrative purposes only, as the device may use energy production of the solar panel, without a separate sensor, to determine when to fire the strobe.

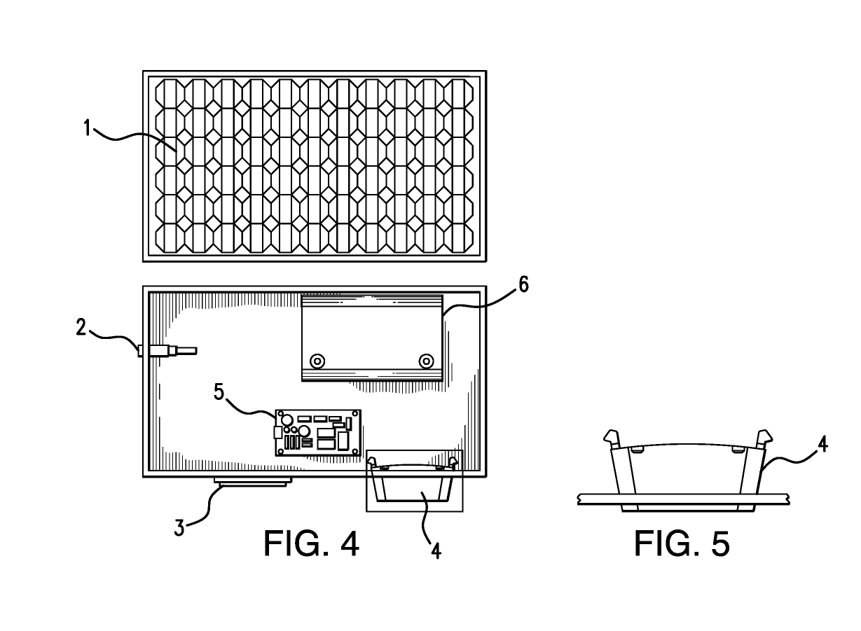

FIG. 4 is the top view of the device, as in Sheet 1, but with the solar panel 1 is placed above for illustrative purposes so that the internal components of the device may be seen. Thus, FIG. 4 shows the top of the device and the solar panel 1 removed to make the interior of the device visible. Said power source provides electricity to the internal power source. The internal power source of the device in this depiction is a battery 6 of sufficient power to power the motion detector 3, which signals via the microprocessor or circuit board 5 when conditions exist for the strobe unit 4 to fire and repel wildlife or intruders.

Note that a photovoltaic sensor 2 which may or may not be used for the circuit board/microprocessor 5 to determine if ambient light conditions are such that firing of the strobe would be effective. An alternative is to use the strength of electricity production of the solar panel to determine ambient light conditions.

Also note FIG. 5 in the lower right corner, which is a depiction of an alternate placement of the strobe unit 4. This alternate placement of the strobe unit within the body of the case, rather than placed on the surface as in the main depiction of the device, is done to illustrate that the depictions of these drawings may well change with regard to the placement, size, type and combination of components within the device. Further the case of the device, depicted in all drawings as a simple rectangular box for illustrative purposes, may well have a variety of different shapes suitable for different environments, specific applications and various placement options, among other things.

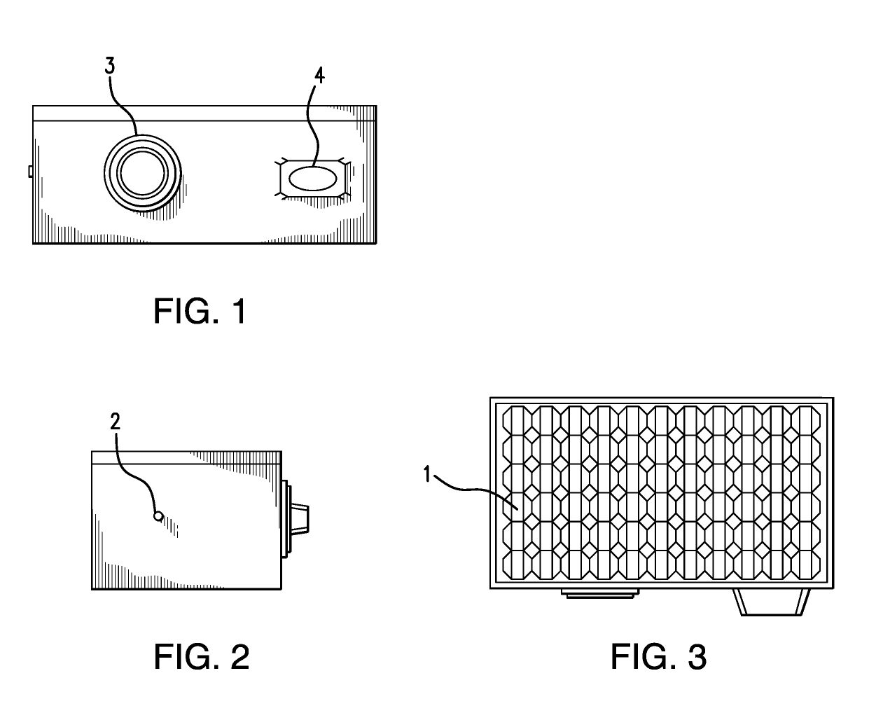

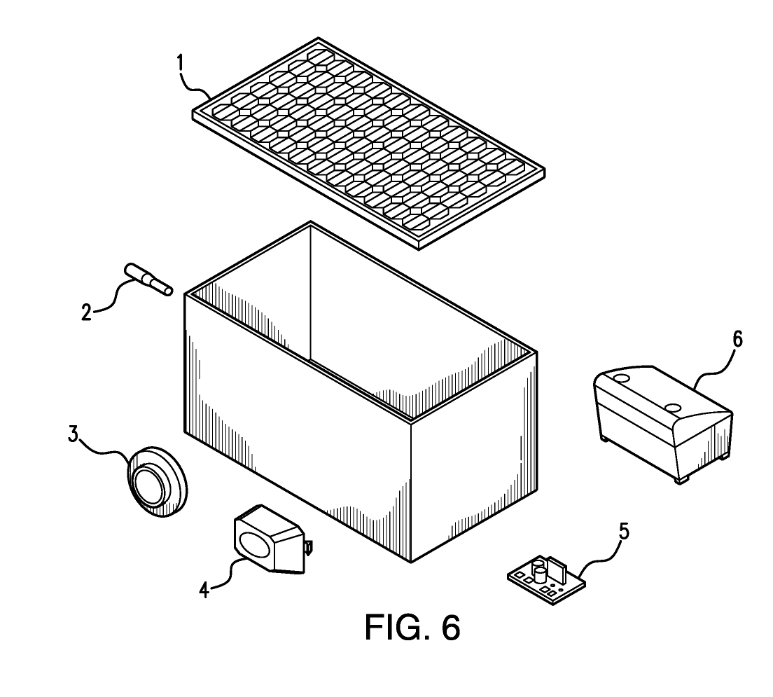

In FIG. 6, the device is seen in “exploded” 3-D view. The components are as in FIGS. 1-5, in that the components are a solar panel 1 which provides power to the device through an electrical storage unit 6 (e.g., a battery), which powers a motion detector 3 whose signal is processed by a microprocessor or circuit board 5 which determines, with feedback on ambient light conditions from either the solar panel 1 or, separately, a photovoltaic sensor 2, whether to fire the strobe or flash unit 4.

Not named as a separate figure in any of the drawings of these sheets is the case itself of the unit, which, as mention above, may take a variety of form factors, and which may be made out of a variety of materials, such as, but not limited to ABS plastic, metal, or even organic materials such as wood.

The invention consists of a case which houses the following components. The case may be designed and manufactured in a variety of different form factors such that it may be placed or mounted in a variety of ways and positions on a number or surfaces, objects or plants in order to be effective.

The case contains an electrical power source. This may typically be a solar panel 1. An electrical power storage unit. This may typically be a battery or batteries 6. A motion sensor 3. This may typically be a ultrasonic or infrared sensor device. A processor or integrated circuit 5 where necessary which controls inputs from the various sensors and power units and determines when to release the sensory deterrent, which in this example is a strobe or flashing light 4.

An ambient light sensor may be either a separate photovoltaic unit or an integration of inputs and functions from the solar panel on the processor or integrated circuit, if so equipped. A sensory deterrent. In this example a strobe or flash unit 4.

The above description and examples should not be construed as limitations on the scope of the invention. Many other variations are possible. Accordingly, the scope of the invention is determined by the claims and their legal equivalents.

The problem of unwanted encroachment on human habitation is one which has been with us since the dawn of man. In the present era, problems of encroachment by wildlife have adopted distinctly different characteristics depending on the part of the world; in developing regions such as certain parts of sub-Saharan Africa the problem of negative interactions with megafauna such as elephants is real and may have extremely negative consequences for both humans and the animals. In parts of the developed world, the problem of encroachment may have tragic consequences as well, but is generally limited to more specific issues such as motor vehicle-herbivore accidents. At the same time, wildlife can be a nuisance in parts of the developed world as well. The problem in much of the developed world is not due to megafauna such as elephants or feral predators such as lions or hyenas, but more commonly due to herbivores. Because humans have rid the environment in the developed world of natural predators, herbivore populations may grow unnaturally large in certain, typically rural, areas, causing harmful problems such as motor vehicle traffic accidents, or nuisance issues such as destruction of crops or gardens.

The present invention is designed to address problems such as those described above in both the developed and developing world in a non-toxic, non-lethal and non-harmful way. The device is self-contained, requires no management beyond initial set-up, and does not constitute any kind of danger to the environment in general.

The device described herein is an apparatus which mitigates the effects of negative human-wildlife interaction of all kinds by both deterring the wildlife from specific areas, and alerting humans to the presence of said wildlife.

Said device comprises a case, a power source, a power storage unit, a sensor to detect motion within a desired range, a controlling entity, and a sensory deterrent of some kind such as a flash or strobe.

It is claimed that the device will deter wildlife from areas to which it provides coverage, such as, but not limited to, crops or habitations. It does so by destroying the animals' night vision via high powered strobe or flashing light, or a similarly unpleasant sensory stimulation. The device is different from the current state of the art which comprises devices such as lights which may go on or off in the presence of intruding wildlife, but which do not specifically provide an actively unpleasant, and thus effective, deterrent.

Similarly, it is claimed that the device described herein provides a better form of alerting humans to the presence of animals along the side of the road, for example, than the current state of the art, which may consists solely of passively-flashing lights alerting drivers to the general presence of wildlife, but not specifically the exact location. If placed in areas of historically significant wildlife activity along roadways, the strobe effect of the lights may act as a cautionary device which may mitigate, or even prevent wildlife accidents completely as drivers are alerted to the presence of animals in specific, rather than general, areas.

The case of the device contains the device's components and provides protection from the environment, increasing the longevity and usefulness of the device as a whole. The case may be manufactured of any appropriate materials including but not limited to such materials as metal, a plastic such as ABS or organic material, such as wood.

The power source of the device comprises an element such as a solar panel, which stores energy in a storage device such as a battery, which energy is then used, when ambient conditions are suitable, by the motion detector to signal to the microprocessor or circuit board, when the deterrent, in this case a strobe or flash unit, should be activated.

In this example, the solar panel powers the battery which powers the circuit board or microprocessor which takes inputs from the solar panel or ambient light sensor to determine whether to provide power to the motion detector, and if the motion detector provides such a signal, whether to fire the strobe or flash unit.

It is claimed that the simplicity, robustness and ease of manufacture of the device will allow widespread distribution and use of the device in a manner not possible with more complex and less robust systems.

1. A wildlife deterrent device, comprising:
a case,
a power source,
a power storage unit,
a sensor to detect motion within a desired range,
a controller, and
a sensory deterrent.

2. The wildlife deterrent device of claim 1, wherein the sensory deterrent is at least one of a flash and strobe.

3. The wildlife deterrent device of claim 1, further comprising:
an ambient light sensor.

4. The wildlife deterrent device of claim 3, wherein the ambient light sensor is at least one of (i) a separate photovoltaic unit and (ii) a unit integrated with at least one of power source and controller.
